(19) United States
(12) Patent Application Publication
(10) Pub. No.: US 2007/0150612 A1
(43) Pub. Date: Jun. 28, 2007

(54) METHOD AND SYSTEM OF PROVIDING MULTIMEDIA CONTENT

(76) Inventors: David Chaney, McKinney, TX (US); Albert S. Baiocchi, Wadsworth, IL (US)

Correspondence Address: ADVANTIA LAW GROUP, 9035 SOUTH 1300 EAST, SUITE 200, SANDY, UT, 84094, US

(21) Appl. No.: 11/535,929

(22) Filed: Sep. 27, 2006

Related U.S. Application Data
(60) Provisional application No. 60/730,796, filed on Oct. 26, 2005.
(60) Provisional application No. 60/721,200, filed on Sep. 28, 2005.

(51) Int. Cl. G06F 15/16

(52) U.S. Cl. 709/231

(57) ABSTRACT

A method and system of providing multimedia content. There includes: capturing audio data; capturing full motion video data; collecting the data in a single file; chroma-keying and masking the full motion video data; including the mask in the single file; storing the single file; providing a calling module that calls playback of the single file; providing the single file over the network; and playing the single file in a browser layer. Playing the single file includes displaying the full motion video data over a functional webpage. Displaying the full motion video data includes a first mode, obscuring a functional portion of a webpage, and a second mode, not obscuring a functional portion of a webpage. The triggering event includes a browser executing the webpage program module, and a user action selected from the group: closing a browser window, moving an indicator over a display, and actuating a display.

### CROSS-REFERENCE TO RELATED APPLICATIONS

This invention claims priority, under 35 U.S.C. § 120, to the U.S. Provisional Patent Application No. 60/730,796, to Albert S. Baiocchi and David Chaney, filed on 26 Oct. 2005, which is incorporated by reference herein. This invention also claims priority under 35 U.S.C. § 120, to the U.S. Provisional patent application No. 60/721,200 entitled, SYSTEM AND METHOD FOR OVERLAYING LIVE MOTION VIDEO ON A WEBSITE, to Albert S. Baiocchi and David Chaney, filed on 28 Sep. 2005, which is incorporated by reference herein.

### BACKGROUND OF THE INVENTION

1. Field of the Invention

The present invention relates to providing multimedia content, specifically to providing multimedia content over a webpage.

2. Description of the Related Art

In the related art, it has been known to play media over networks. Playing graphics over a network has become an increasingly effective way to share information, visualize data, design components, and advertise products. Previously, graphics and other video media and the like have been played over networks through a variety of data-transfer technologies, such as downloading and streaming.

Playing media over a network by downloading involves storing the media for future rendering. When a computer user requests for the media to play, a server retrieves the media from storage and delivers it to the computer user over the network. Once the media is received by the computer user, a media player renders it and plays it on a display. Such methods may require a considerable amount of time to download. Accordingly, some systems stream media in order to reduce an effective delivery time.

Streaming video is a sequence of moving images that are sent in an often compressed form over the Internet, or local area network, and are displayed to the viewer as they arrive. Streaming media may include streaming video and streaming audio. With streaming media, a computer user does not have to download a file before seeing the video or hearing the sound. Instead, the media is sent in a continuous stream and is played as it arrives. Streaming video is usually sent from prerecorded video files, but can be distributed as part of a live broadcast. However, producing such representations may involve significant server computing and storage resources, as well as require large amounts of time.

Video and/or images may also be altered, edited, and/or conditioned for delivery. One example of such is chroma-keying. The chroma-key process, also known as color separation overlay, color keying, blue-screening, and green-screening, is a graphical effect that composites two images together. For example, television weather broadcasts are often chroma-keyed to enable simultaneous display of weather information together with video showing a weatherperson.

The chroma-key process involves: isolating visual information, typically a particular color or color range, from a first image; removing the isolated visual information from the first image by making it transparent; and combining the first image with a second image so that the second image can be seen in place of the isolated visual information. Accordingly, a series of images may be altered to suit a particular purpose.

A media provider may provide media over a network for a variety of reasons, such as: to provide instruction, to provide advertisements, to conduct business, to perform transactions, to provide entertainment, and/or to provide information. Similarly, a computer user may play media over a network for many purposes. Some reasons why a computer user may want to play media over a network may be: to receive instruction, to perform transactions, to observe entertainment, and/or to access information.

As consumer demand for network media delivery increases, so does the demand for better quality content, increased content of delivery, and increased efficiency of media delivery. Some improvements have been made in the field. Examples include but are not limited to the references described below, which references are incorporated by reference herein:

U.S. Patent Application Publication No.: 2004/0109014, by Henderson, discloses a method and system for displaying superimposed non-rectangular motion-video images in a windows use interface environment. Presentation of composited video images on a digital user interface enables an actor to move independently of the underlying application windows, increasing the dramatic effect and allowing accompanying digital content to be displayed in a complementary fashion. Chroma-key operation on the frames of the video image to detect a foreground portion of each frame provides a robust response to non-uniform background colors or to artifacts introduced during compression and transmission by threshold comparison of a variation of pixels in the frame to an expected or detected background color and value.

U.S Pat. No. 6,288,753, issued to DeNicola et al., discloses a system and method for an interactive, Internet-based videoconferencing multicast operation which utilizes a video production studio with a live instructor giving lectures in real-time to multiple participating students. The videoconference multicast permits the students to interact with the instructor and other installations during the course of the lecture. In the case of software training, the system and method also utilize Internet-based application sharing and collaboration to permit the students at remote locations to drive a studio-based computer with the software for which the training is being given. The software screen is then used as a background with the instructor being able to literally point to areas of the screen which are being discussed. The instructor has a set of monitors in the studio which allow him/her to see the students on-location. In this fashion, the students can see at their computer screens the instructor “walking” around their computer screen pointing at various items on the screen. Furthermore, a system and method for on-line testing, evaluation and reporting is disclosed wherein test questions, which can be created on the fly by a test administrator, are stored in a database and associated with one or more test numbers and whereby each time a student requests to take a test, the test is “built” and the order of the questions is randomized to avoid cheating. Test evaluation data is cross-correlated and made instantaneously available to students and their sponsoring employer.

U.S. Pat. No. 6,384,821, issued to Borrel et al., discloses a system and method for seamlessly combining client-only rendering techniques with server-only rendering techniques. The approach uses a composite stream containing three distinct streams. One stream is available to send geometry from the server to the client. Another stream contains video with transparent pixels that allow the client-rendered object to appear in the context of the server rendered objects. The third stream contains camera information. The invention can satisfy a number of viewing applications. For example, initially the most relevant geometry can stream to the client for high quality local rendering which the server delivers renderings of less relevant geometry at lower resolutions.

U.S. Pat. No. 6,788,309, issued to Swan et al., discloses a method and apparatus for generating a video overlay. A method and apparatus utilizes a display engine scaler to access source image that is located in memory, such as a frame buffer and also controls a second scaler, such as a front end scaler of a 2D/3D engine, which also accesses the frame buffer and is capable of scaling from a frame buffer memory and storing the scaled image back to the frame buffer.

U.S. Patent Application Publication No. 2004/0128342, by Maes et al., discloses a system and method for generating streamed broadcast or multimedia applications that offer multi-modal interaction with the content of a multimedia presentation. Mechanisms are provided for enhancing multimedia broadcast data by adding and synchronizing low bit rate meta-information which preferably implements a multi-modal user interface. The meta information associated with video or other streamed data provides a synchronized multi-modal description of the possible interaction with the content. The multi-modal interaction is preferably implemented using intent-based interaction pages that are authored using a modality-independent script.

U.S. Patent Application Publication No. 2002/0069411, by Rainville et al., discloses a system for enhancing the display of World Wide Web pages combined with television video signals on a TV screen includes enhanced display modes. In a first embodiment, the viewer controls the transparency of a Picture-In-Picture image (PIP). A PIP image that normally covers up a part of the background image is made transparent so that the user can view the image through the PIP image. Using transparency control, two same size images are simultaneously viewed whereby a full size background image and a full size foreground image simultaneously occupy the full television video screen. In a second embodiment of enhanced display of television video and World Wide Web graphics, a television video Picture-In-Graphics (PIG) image is imbedded as an object in an HTML Web page. When the HTML Web page is displayed as a background image and scrolled (or panned), the television video PIG image scrolls along with the HTML Web page background image.

The inventions heretofore known suffer from a number of disadvantages, which include: being unable to travel over a webpage; being confined to a box on a webpage; being unable to function concurrently with a functional webpage; being operable only in a Windows-based user system; having a choppy presentation; having an inability to provide both audio and visual media in a single file, being affected by changing to a different webpage; being unable to run on a browser; having limited viewable image size; and/or being unable to play at high speeds.

What is needed is a method and system of providing multimedia content that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available methods and systems of providing multimedia content. Accordingly, the present invention has been developed to provide a method and system of providing multimedia content.

In one embodiment, there is a method of providing multimedia content, including: capturing audio data; capturing full motion video data; collecting the audio data and/or the full motion video data together in a single file; storing the single file in a data storage module in communication with a network; providing a calling module that calls playback of the single file, only through a browser, when the calling module is included in a webpage program module in communication with the network and/or triggered by a triggering event; providing the single file over the network when called by the calling module; and/or playing the single file.

In another embodiment, the step of playing the single file includes a step of displaying the full motion video data over a functional webpage. In yet another embodiment, the step of displaying the full motion video data includes an instance of a first mode wherein a functional portion of a webpage may be obscured and/or an instance of a second mode wherein the functional portion of the webpage may not be obscured. In still another embodiment, the method of providing multimedia content includes the step of providing a browser layer, wherein the step of playing the single file may be performed in the browser layer. In still yet another embodiment, the triggering event includes a browser executing the webpage program module.

In even another embodiment, the method of providing multimedia content includes the steps of: chroma-keying the full motion video data; masking a foreground of the chroma-keyed full motion video data; and/or including the masked foreground full motion video data in the single file. In even yet another embodiment, the triggering event includes a user action selected from the group consisting of: closing a browser window, moving an indicator over a display region, and/or actuating a display region. In even still another embodiment of the invention the single file may be a streaming video file that plays an alpha key; and/or the calling module includes: a layer creation module, configured to create the browser layer, a video play module, configured to direct playback of the single file, and/or a transparency module, configured to cause the browser layer to be transparent.

In an additional embodiment of the invention, there is a multimedia presentation system for providing audio and video data, including: an audio data capture module, configured to capture audio data; a full motion video data capture module, configured to capture full motion video data; a data collection module, in communication with the audio data capture module and/or the full motion video data capture module, and/or configured to collect the audio data and full motion video data together in a single file; a data storage module, in communication with the data collection module, and/or configured to store the single file; and/or a calling module, in communication with the data storage module, including instructions to call playback of the single file through a browser and/or display the single file over functional browser content when triggered by a triggering event.

In yet an additional embodiment, the multimedia presentation system includes: a player module, in communication with the calling module, and/or configured to play the single file. In still an additional embodiment, the player module includes: a first obstruction mode, configured to obstruct a portion of the functional browser content; and/or a second access mode, configured to provide access to a portion of the functional browser content. In still yet an additional embodiment, the multimedia presentation system includes: a browser layer, in communication with the player module, wherein the single file may be played in the browser layer.

In even an additional embodiment, the multimedia presentation system includes: a chroma-key module, in communication with the data collection module, and/or configured to chroma-key the full motion video data. In even yet an additional embodiment, the single file may be a streaming video file that plays an alpha key. In even still an additional embodiment, the calling module includes: a layer creation module, configured to create the browser layer; a video player module, configured to direct playback of the single file; and/or a transparency module, configured to cause the browser layer to be transparent.

In a further embodiment, there is a method of providing multimedia content, including: capturing data; capturing full motion video data; collecting the audio data and the full motion video data together in a single file; storing the single file in a data storage module in communication with a network; providing a single file over the network when triggered by a triggering event; and/or playing the single file by displaying the full motion video data over a functional webpage.

In yet a further embodiment, the step of displaying the full motion video data includes an instance of a first mode wherein a functional portion of a webpage may be obscured and/or an instance of a second mode wherein the functional portion of the webpage may not be obscured. In still a further embodiment, the method of providing multimedia content includes providing a browser layer, wherein the step of playing the single file may be performed in the browser layer. In still yet a further embodiment, the triggering event includes a browser executing a webpage program module. In even a further embodiment, the triggering even includes a use action selected from the group consisting of: closing a browser window, moving an indicator over a display region, and/or actuating a display region.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a flow chart of a method of providing multimedia content, according to one embodiment of the invention;

FIG. 2 is a flow chart of a method of providing multimedia content, according to one embodiment of the invention;

FIG. 3 is a block diagram of a multimedia presentation system, according to one embodiment of the invention;

FIG. 4 is a block diagram of a provider module, according to one embodiment of the invention;

FIG. 5 is a block diagram of a web host module, according to one embodiment of the invention;

FIG. 6 is a block diagram of a user module, according to one embodiment of the invention;

FIG. 7 is a representational screen shot of a webpage displaying multimedia content, according to one embodiment of the invention; and

FIG. 8 is a representational screenshot of a webpage displaying multimedia content, according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment. ” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of. ”

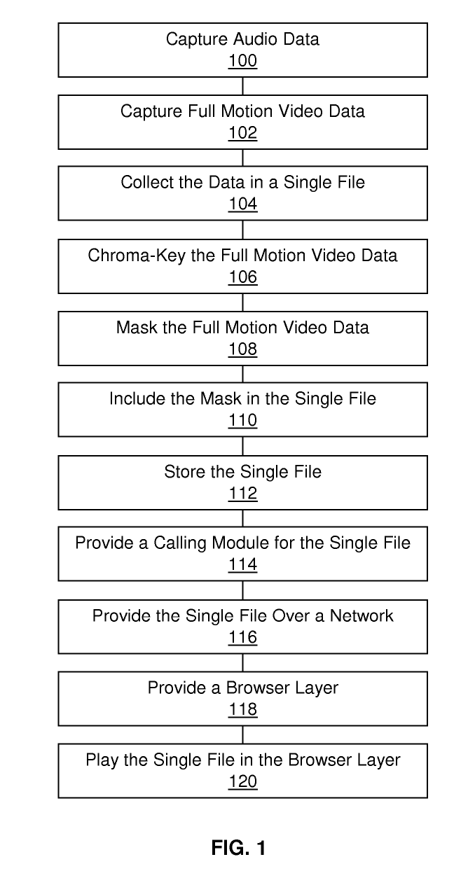

FIG. 1 illustrates a flow chart of a method of providing multimedia content, according to one embodiment of the invention. As illustrated, audio data and full motion video data are captured 100, 102, and collected 104, in a single file. Then, the full motion video data is chroma-keyed 106 and masked 108. After the full motion video data is masked 108, the masked 108 full motion video data is included 110 in the single file. The single file is stored 112, and a calling module is provided 114 for calling the single file. Also, a browser layer is provided 118, and the single file is played 120 in the browser layer 118.

In one embodiment of the invention, audio data and full motion video data are filmed by a video camera, such as the HVR-V1U professional camcorder, by Sony Corporation of America, of New York, N.Y. Then, the recorded audio data and filmed full motion video data are captured 100, 102, respectively, into memory by video capture software, such as Adobe Premiere Pro 2.0, by Adobe Systems Inc., of San Jose, Calif. Once captured 100, 102, the audio data and the full motion video data are collected 104 in a single file. The audio data and full motion video data are collected 104 in a single file by saving the audio data and the full motion video data as an Audio Video Interleave (AVI) file, a multimedia container format by Microsoft Corporation of Redmond, Wash. The AVI file may also use the file format extensions of the Matrox OpenDML group of Matrox Electronic Systems, Ltd., of Dorval Quebec.

After the audio data and the full motion video data are collected 104 in a single file, the full motion video data may be chroma-keyed 106. Chroma-keying involves isolating visual information, typically a particular color or color range, from the full motion video data. Visual information may be isolated from the full motion video data by software, such as the program Ultra, by the Serious Magic Corporation of Folsom, Calif., which creates a 32-bit alpha channel AVI file. Once visual information is chroma-keyed 106, it may be masked 108, or made transparent. For example, a foreground of the full motion video may be masked 108 by software, such as Adobe After Effects 6.5, by Adobe Systems, Inc., of San Jose Calif. Then, the masked 108 full motion video data is included 110 in the single file and the single file is stored 112. The masked 108 full motion video data may be included 110 in the single file and stored 112 as a Macromedia Flash Video File (FLV) by the VP6 True Motion video codec, by On2 Technologies, of New York, N.Y. , with the encode alpha channel setting selected.

Additionally, a calling module and a browser layer are provided 114, 118, respectively. The calling module is in communication with a network and may include a Flash Player such as the Macromedia Flash Player 8, by Marcomedia, Inc., of San Francisco Calif. Further, the browser layer 118, may be a Hyper Text Markup Language (HTML) layer which may be provided in a browser, such as but not limited to Internet Explorer by Microsoft Corporation of Redmond Wash. (Other examples include Opera, www.opera.com, and Firefox, www.mozilla.com). The calling module calls playback of the single file and plays 120 the single file in the browser layer 118. The calling module 114 may call playback of the single file and play 120 the single file in the browser layer 118 by using webpage scripting language, such as Dynamic Hyper Text Markup Language (DHTML), to create a timeline, and by placing the webpage scripting language in the browser layer 118.

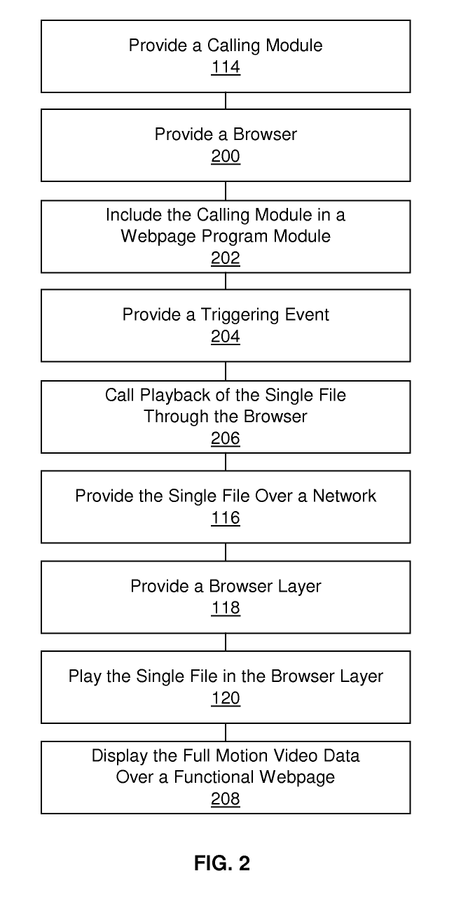

Looking to FIG. 2, there is illustrated a flow chart of a method of providing multimedia content, according to one embodiment of the invention. According to the illustration, a calling module and a browser are provided 114, 200, respectively. The calling module is included 202 in a webpage program module. After a triggering event is provided 204, playback of the single file is called 206 through the browser 200, and the single file is provided 116 over a network. A browser layer is also provided 118 and the single file is played 120 in the browser layer, displaying 208 the full motion video data over a functional webpage.

In one embodiment of the invention, the calling module is included 202 in a webpage program module. The calling module may be such as the Macromedia Flash Player 8, by Marcomedia, Inc., of San Francisco Calif., and the webpage program module may include webpage scripting language, such as Dynamic Hyper Text Markup Language (DHTML) placed in the HTML code of a webpage. For example, creating the webpage program module may include the following steps: 1. creating a layer and naming the layer “o3dvideo” using the code <div id=“o3dvideo” style=“position:absolute”; 2. inserting the single file into the “o3dvideo” layer; and 3. making the single file transparent using the code <param name=“wmode” value=“transparent”>.

In addition, the calling module calls 206 playback of the single file through the browser when triggered 204 by a triggering event. The browser may be a program such as Internet Explorer 7, by Microsoft Corporation, of Redmond, Wash. Furthermore, the calling module may be triggered 204 to call 206 playback of the single file by a triggering event, such as, but not limited to: a browser executing the webpage program module, a user closing a browser window, a user moving an indicator (such as but not limited to a mouse pointer) over a display region, and a user actuating a display region (such as but not limited to by clicking). As non-limiting examples, a calling module and triggering event may function to display media as a pop-up, pup-under, or banner.

Also, when playback is called 206 by the calling module, the single file is provided 116 over a network, and played 120 in the browser layer 120, displaying 208 the full motion video data over a functional webpage. For example, the network may be the World Wide Web, and the browser layer may be may be a Hyper Text Markup Language (HTML) layer. The calling module may call 206 playback of the single file and play 120 the single file in the browser layer by using the webpage program module.

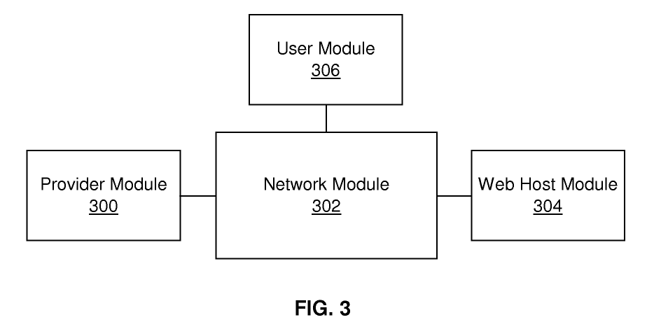

FIG. 3 illustrates a block diagram of a multimedia presentation system, according to one embodiment of the invention. As illustrated there is a network module 302. As one non-limiting example, the network module 302 may include the Internet. In communication with the network module 302 are a provider module 300, a web host module 304, and a user module 306. Each of modules 300, 304, and 306 may be in communication one with another and such may be through the network module 302. The network module may include an intranet, a wireless network, a plurality of diverse networks providing communication therethrough, etc.

The provider module 300 provides multimedia content that is displayed over the web host module 304 content. In one embodiment of the invention, the provider module 300 includes: a multimedia file, a server, connectivity to the network module 302, addressing required to reach the network module 302, and a plurality of modules required to create the multimedia file. For example, the modules required to create the multimedia file may include: a video camera, such as the HVR-V1U professional camcorder, by Sony Corporation of America, of New York, N.Y.; video capture software, such as Adobe Premiere Pro 2.0, by Adobe Systems Inc., of San Jose, Calif.; an Audio Video Interleave (AVI) file, a multimedia container format by The Microsoft Corporation of Redmond, Wash.; file format extensions of the Matrox OpenDML group of Matrox Electronic Systems, Ltd., of Dorval Quebec; the program Ultra, by the Serious Magic Corporation of Folsom, Calif., which creates a 32-bit alpha channel AVI file; Adobe After Effects 6.5, by Adobe Systems, Inc., of San Jose Calif.; and/or the VP6 True Motion video codec, by On2 Technologies, of New York, N.Y, with the encode alpha channel setting selected.

The web host module 304 receives multimedia content and displays the multimedia content over the web host module 304 content. In one embodiment of the invention, the web host module 304 includes: a webpage that a user is accessing; software on a webpage; a server; and connectivity to the network module 302. For example, the web host module 304 may include: a Flash Player such as the Macromedia Flash Player 8, by Marcomedia, Inc., of San Francisco Calif.; a browser layer, such as a Hyper Text Markup Language (HTML) layer; webpage scripting language, such as Dynamic Hyper Text Markup Language (DHTML); and/or Internet Explorer 7, by Microsoft Corporation, of Redmond, Wash.

The user module 306 activates receipt and display of the multimedia content over the web host module 304. In one embodiment of the invention, the user module 306 includes: user software or a content module. For example, the user's software may include: Internet Explorer 7, by Microsoft Corporation, of Redmond, Wash.; and/or Macromedia Flash Player 8, by Marcomedia, Inc., of San Francisco Calif. Further, in one embodiment of the invention, the content module may include any module that reads HTML and JavaScript and/or provides video content or audio/video content to a viewer. As non-limiting examples, the content module may be: a browser, an email viewer, and/or a chat window.

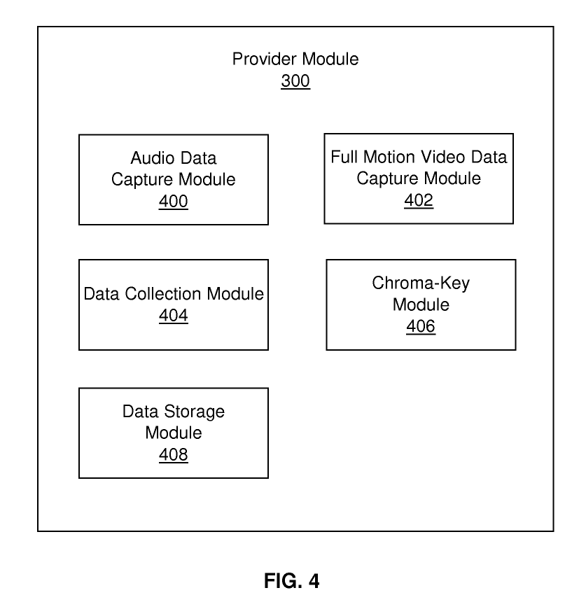

FIG. 4 illustrates a block diagram of a provider module 300, according to one embodiment of the invention. Included in the provider module 300 are: an audio data capture module 400, a full motion video data capture module 402, a data collection module 404, a chroma-key module 406, and a data storage module. In one embodiment of the invention, the audio data capture module 400, and the full motion video data capture module 402, include: a video camera, such as the HVR-V1U professional camcorder, by Sony Corporation of America, of New York, N.Y.; and/or video capture software, such as Adobe Premiere Pro 2.0, by Adobe Systems Inc., of San Jose, Calif.

Additionally, in one embodiment of the invention, the data collection module 404 includes: an Audio Video Interleave (AVI) file, a multimedia container format by The Microsoft Corporation of Redmond, Wash.; and/or file format extensions of the Matrox OpenDML group of Matrox Electronic Systems, Ltd., of Dorval Quebec. Also, in one embodiment of the invention, the chroma-key module 406 includes: the program Ultra, by the Serious Magic Corporation of Folsom, Calif., which creates a 32-bit alpha channel AVI file; and/or software, such as Adobe After Effects 6.5, by Adobe Systems, Inc., of San Jose Calif. Further, in one embodiment of the invention, the data storage module 408 includes a Macromedia Flash Video File (FLV) by the VP6 True Motion video codec, by On2 Technologies, of New York, N.Y., with the encode alpha channel setting selected.

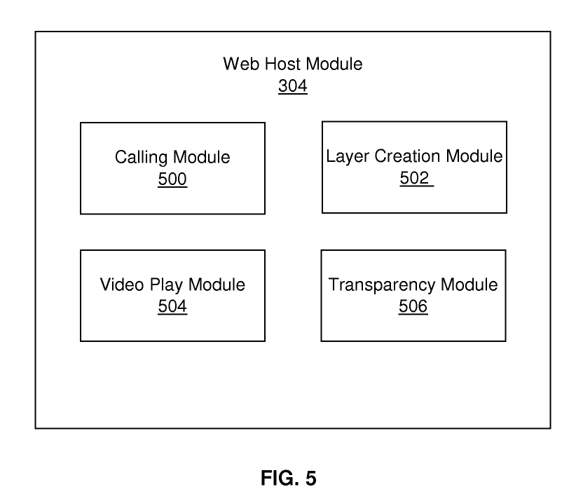

FIG. 5 illustrates a block diagram of a web host module 304, according to one embodiment of the invention. Included in the web host module 304 are: a calling module 500, a layer creation module 502, a video instruction module 504, and a transparency module 506. In one embodiment of the invention, the calling module 500 includes a Macromedia Flash Player 8, by Marcomedia, Inc., of San Francisco Calif. In addition, in one embodiment of the invention, the layer creation module 502 includes webpage scripting language, such as Dynamic Hyper Text Markup Language (DHTML) placed in the HTML code of a webpage. For example, the webpage scripting language of the layer creation module 502 may include the following steps: 1. creating a layer and naming the layer “o3dvideo” using the code <div id=“o3dvideo” style=“position:absolute”; and 2. inserting the single file into the “o3dvideo” layer.

Also, in one embodiment of the invention, the video instruction module 504 includes: a program such as Internet Explorer 7, by Microsoft Corporation, of Redmond, Wash.; and/or a browser layer, such as a Hyper Text Markup Language (HTML) layer. Further, in one embodiment of the invention, the transparency module 506 includes includes webpage scripting language, such as Dynamic Hyper Text Markup Language (DHTML) placed in the HTML code of a webpage. For example, the webpage scripting language of the transparency module 506 may include the following steps 2. inserting the single file into the “o3dvideo” layer; and 3. making the single file transparent using the code <param name=“wmode” value=“transparent”>

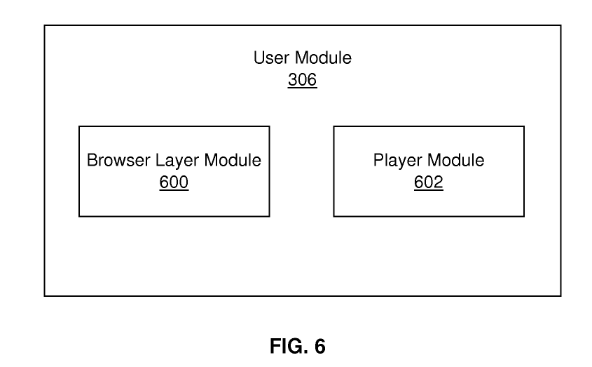

FIG. 6 illustrates a block diagram of a user module 306, according to one embodiment of the invention. Included in the user module 306 are: a browser layer module 600; and a player module 602. In one embodiment of the invention, the browser layer module 600 may include: a client side HTML and/or javascript web based application that is a part of the browser/HTML stack that may be generated through a command implemented by a browser program such as Internet Explorer 7, by Microsoft Corporation, of Redmond, Wash.; a Hyper Text Markup Language (HTML) layer; and/or webpage scripting language, such as Dynamic Hyper Text Markup Language (DHTML) placed in the HTML code of a webpage. Additionally, in one embodiment of the invention, the player module 602 includes: a Flash Player such as the Macromedia Flash Player 8, by Marcomedia, Inc., of San Francisco Calif.; and/or a Hyper Text Markup Language (HTML) layer.

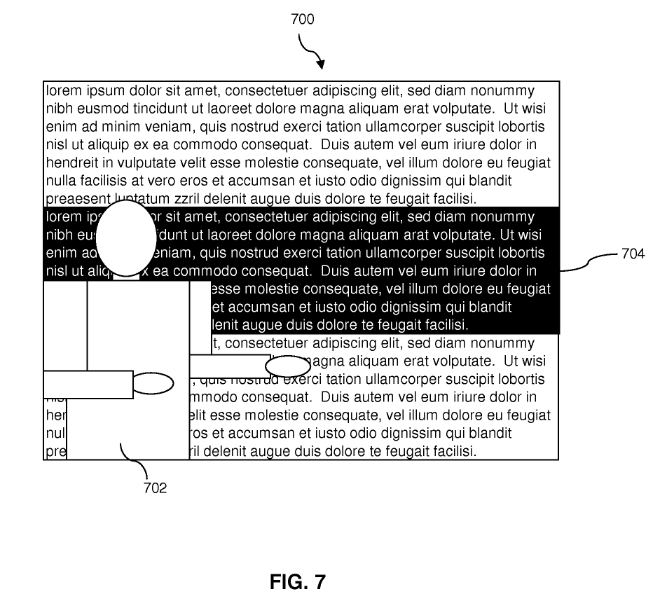

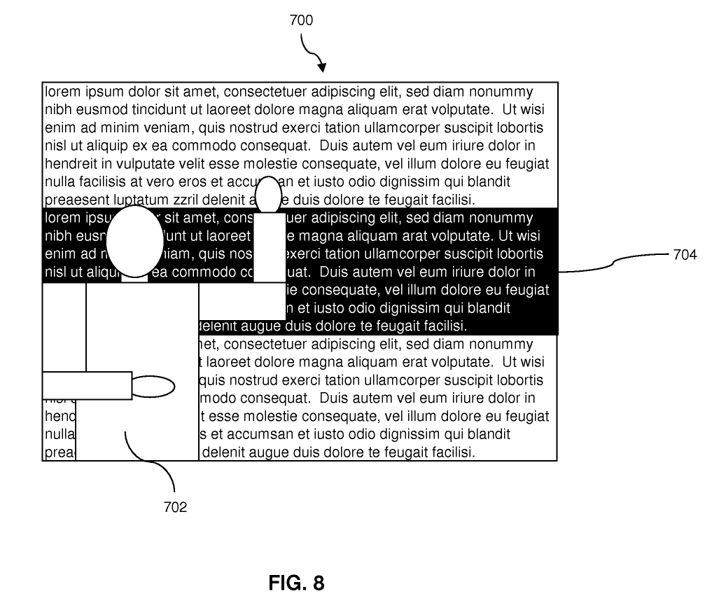

Looking to FIGS. 7 and 8, there is illustrated a representational screen shot of a webpage 700 displaying multimedia content 702. As illustrated, the multimedia content 702 overlays a functional portion 704 of the webpage 700. As shown, the multimedia content 702 may move and/or change configuration without disrupting the functional portion 704 of the webpage 700. Accordingly, in one embodiment of the invention, there is remaining functionality in the functional portion 704 of the underlying webpage 700, such that the underlying webpage 700 may be changed, and the multimedia content 702 overlay may continue despite the changed webpage 700. For example, a user may select text behind the multimedia content 702 for use, such as, but not limited to for performance of a copy/paste function.

In order to demonstrate the practice of the present invention, the following examples have been prepared. The examples should not, however, be viewed as limiting the scope of the invention. The claims will serve to define the invention.

### EXAMPLE 1

The first step in the process is to film a subject in front of a solid-color backdrop, typically a solid blue or green screen. Once a subject has been filmed, with a solid background of blue or green behind the subject, the blue or green color is removed from the video image using the chroma-key process. In order to chroma-key the blue or green color from the video footage, the blue or green screen footage is captured into memory using standard techniques and commercially available video capture software, such as Adobe Premiere Pro 2.0, by Adobe Systems Inc., of San Jose, Calif. The video footage is then saved as an Audio Video Interleave (AVI) file with the file format extensions developed by the Matrox OpenDML group of Matrox Electronic Systems, Ltd., of Dorval Quebec. The AVI file footage is then imported into software, such as the program Ultra, created by the Serious Magic Corporation of Folsom, Calif. Using Ultra's Vector Keying™process, the blue or green background from the footage is keyed out, and 32-bit alpha channel AVI file is created. The alpha channel is a mask that specifies how the pixel's colors should merge with another pixel with the two are overlaid, one on top of the other.

After the 32-bit AVI file is created, it is imported into software, such as Adobe After Effects 6.5, by Adobe Systems, Inc., of San Jose Calif. Using Adobe After Effects 6.5, a mask around the person or subject is created. Graphics or text may also be added to the image at this point. The masked object is then exported as a Macromedia Flash Video File (FLV) using the On2 VP6 True Motion video codec, by On2 Technologies, of New York, N.Y., with the encode alpha channel setting selected. The FLV file may also be associated with video player, or SWF, files by ActionScript external references.

After the FLV alpha channel is exported, software such as Macromedia Flash Player 8, by Marcomedia, Inc., of San Francisco Calif. is used to create a video player to play the FLV file over a webpage. Using the Macromedia Flash Player 8 component, the FLV file is referenced to load into the player and be delivered from a server. Once the reference or link between the player and the FLV file is established, an SWF file may be exported or published.

Very simple playback of the FLV file is controlled by a timeline and ActionScript. The ActionScript may reference objects within the SWF file or resources external to it, e.g., Macromedia FLV files. Further, instructions, such as but not limited to HTML, may be created to place the SWF over a webpage. Using webpage scripting language such as DHTML, which allows a layer above or over an existing webpage, an invisible timeline may be created. The following steps may be used:
a) A layer is created and named 37 o3dvideo” using the code <div id=“o2dvideo” style=“position absolute”;
b) The SWF file is inserted into the “o3dvideo” layer; and
c) The SWF file is made transparent using the code <param name=“wmode” value=“transparent.”

Along with the coding of the DHTML layer, the programmer creates a script that check to see if a user has an internet connection speed of 100 k or better. For any connection speed less than 100 k, the code would not engage the timeline to play the large FLV file. After the script checks the broadband speed, the next code verifies that the user has the Macromedia Flash Player 8, or higher player, installed into the browser. If the Macromedia Flash Player 8 is not found, the user will be prompted to install the free player from macromedia.com. After the DHTML code has been written, and the files have been tested, the code is placed in the HTML code of a webpage. Alternatively, the code may be sent via email or downloaded from a webpage for placement into the HTML code of a webpage.

When a webpage is opened, or a button, hypertext, or script of a webpage is activated, the code and/or the SWF player contact the server where the FLV file may be stored, and call for delivery of the media to the user. The FLV file is then delivered to the user and may be played over an existing webpage as an overlay on the existing text and graphics. Advantageously, the existing webpage remains functional during the playing of the streaming FLV file.

### EXAMPLE 2

A user may be enabled to view media content over any website, including a non-affiliated webpage. Initially, a user accesses the demo builder website/module. After accessing the demo builder website, the user is presented with an HTML form. The HTML form includes places to enter a website Universal Resource Location (URL) address, the user's name, the user's email address, and the user's phone number.

After the user enters the information required by the HTML form, the user clicks the Generate button/module. Clicking the Generate button inserts the HTML form entries into a relational database and sends an email to the user with a link to a demo generated for the user. An email may also be sent to an administrator and/or an affiliate reseller with the same contents.

The user may click on the link to the demo, and is taken to a page on the demo builder website. The demo builder website accesses the database of demo links created and finds the URL address of the specific demo identified by an encrypted ID parameter in the link. The demo builder website then makes an asynchronous Hypertext Transfer Protocol (HTTP) call to the URL address, and downloads website content (raw HTML) from the URL address. The downloaded website content is stored in memory on the web server and combined with additional JavaScript code.

Subsequently, the combined website content and JavaScript code are sent with Flash code directly to the user's browser and visually appear to be on a different website URL (the URL specified in the demo link). Next, the Flash movie is displayed with a transparent window mode on top of the website presented. The flash movie also displays a loading progress bar as the video is downloaded. Once the flash movie has been downloaded, it begins to play. Accordingly, a user may very quickly be provided with a customized demonstration of a functioning embodiment of the invention. In one embodiment, there may be a selection of media that may be displayed in connection with the content of the entered URL. As a result, a user may be enabled to view a variety of embodiments.

### EXAMPLE 3

A user may be enabled to view media content over any website, including a non-affiliated webpage. At first, a media display presentation overlaying a website is viewed by a user. During the media display presentation, a form is viewed by the user and the media display prompts the user to fill out the form. For example, the form may be a form for: lead generation, survey questions, or to place an order. Also, as one non-limiting example, the media display may prompt the user to fill out the form by verbally introducing the form to the user. After the user fills out the form, the data in the form is captured by a media content file/module.

In one embodiment, the form data is captured by form HTML code inside a media content file/module. Form HTML code data capture entails an ActionScript command, inside the media content file/module, launching a JavaScript command to display a div layer. The div layer includes a form HTML code that has been inputted by a user or a media content player SWF file/module. Once the div layer is displayed, the div layer captures the form data by using the form HTML code. Alternatively, the div layer may capture the form data by using a media content player SWF file/module.

In another embodiment, the form data is captured by a SWF file/module inside a media content file/module. SWF file/module data capture involves an ActionScript command, inside the media content file/module, prompting another layer inside the media content player/module. Further, the prompted other layer has a prebuilt form that captures data input by the user and sends it to the media content file/module via php, asp, sql, or any other data base script.

Once the form data has been captured, it may be processed by the media content file/module and/or a media content file/module administrator. Accordingly, communication between a user and a media content file/module administrator may take place through the display and capture of form data by a media content file/module. As a result, a user may be enabled to view and interact with a variety of embodiments.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the multimedia content 702 is shown located in the bottom left corner of the webpage 700, the multimedia content 702 may be located in any location on the webpage and/or may travel, or move, along the webpage 700. As one non-limiting example, the multimedia content 702 may be located in the middle of the top of the webpage 700 and may move to the bottom right corner of the webpage 700. Also, the multimedia content 702 may move in accordance with any motion. For example, the multimedia content 702 may sway, or gesture. Accordingly, when the multimedia content 702 moves in accordance with a motion, portions 704 of the underlying webpage 700 may become visible or covered according to the motion. Further, there may be remaining functionality about the webpage 700 around a boundary of the multimedia content 702 overlay.

In addition, although the Figures illustrate the multimedia content 702 as a person, the multimedia content 702 could be any subject. For example, the multimedia content could include: an animal, a machine, video quality animation, insects, etc. Further, the multimedia content 702 could include a plurality of subjects, such as two persons, for example.

Also, although the Figures illustrate the multimedia content 702 as overlying a functional portion 704 of a webpage 700, the multimedia content 702 may not cover, or overly, a functional portion 704 of a webpage 700. For example, the multimedia content may be displayed behind, or outside of, a functional portion 704 of a webpage 700. Further, when the multimedia content 702 is not covering the functional portion 704 of the webpage 700, the functional portion of the webpage 700 may be visible.

It is also envisioned that the multimedia content 702 may have variations on transparency. For example, a boundary around the multimedia content 702 may be generally transparent, with shadowing of the multimedia content 702 to a side of the multimedia content 702. Accordingly, a user may see both the shadow, and the underlying webpage 700. In another example, the transparency of the multimedia content 702 may include any mapping where underlay content 700 is visible through the overlay 702, such as, but not limited to: magnification, color reversing, mirroring, shading, colorizing, and de-colorizing.

Additionally, it is envisioned that full motion video data may be defined as video that is not choppy. For example, full motion video data may include a frame rate of: greater than 10 frames per second (fps), between 10 and 30 fps, greater than 20 fps, greater than 27 fps, approximately 27 fps, and/or greater than 30 fps.

It is further envisioned that the full motion video data may be delivered by a variety of delivery mechanisms, such as, but not limited to: a browser layer, such as an HTML layer; or JavaScript.

Further, it is envisioned that full motion video data may include video capture and/or drawings. For example, full motion video data may include: human subjects; a fluid video presentation; and/or a series of photographic images, consecutive in time.

Finally, it is envisioned that the components of the invention may be constructed of a variety of materials, such as, but not limited to: plastic, metal, and/or glass.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A method of providing multimedia content, comprising:
a) capturing audio data;
b) capturing full motion video data;
c) collecting the audio data and the full motion video data together in a single file;
d) storing the single file in a data storage module in communication with a network;
e) providing a calling module that calls playback of the single file, only through a browser, when the calling module is included in a webpage program module in communication with the network and triggered by a triggering event;
f) providing the single file over the network when called by the calling module; and
g) playing the single file.

2. The method of claim 1, wherein the step of playing the single file comprises a step of displaying the full motion video data over a functional webpage.

3. The method of claim 2, wherein the step of displaying the full motion video data comprises an instance of a first mode wherein a functional portion of a webpage is obscured and an instance of a second mode wherein the functional portion of the webpage is not obscured.

4. The method of claim 3, further comprising the step of providing a browser layer, wherein the step of playing the single file is performed in the browser layer.

5. The method of claim 4, wherein the triggering event comprises a browser executing the webpage program module.

6. The method of claim 5, further comprising the steps of:
a) chroma-keying the full motion video data;
b) masking a foreground of the chroma-keyed full motion video data; and
c) including the masked foreground full motion video data in the single file.

7. The method of claim 6, wherein the triggering event further comprises a user action selected from the group consisting of: closing a browser window, moving an indicator over a display region, and actuating a display region.

8. The method of claim 7, wherein:
a) the single file is a streaming video file that plays an alpha key; and
b) the calling module includes:
b1) a layer creation module, configured to create the browser layer,
b2) a video play module, configured to direct playback of the single file, and
b3) a transparency module, configured to cause the browser layer to be transparent.

9. A multimedia presentation system for providing audio and video data, comprising:
a) an audio data capture module, configured to capture audio data;
b) a full motion video data capture module, configured to capture full motion video data;
c) a data collection module, in communication with the audio data capture module and the full motion video data capture module, and configured to collect the audio data and full motion video data together in a single file;
d) a data storage module, in communication with the data collection module, and configured to store the single file; and
e) a calling module, in communication with the data storage module, including instructions to call playback of the single file through a content module and display the single file over functional content when triggered by a triggering event.

10. The multimedia presentation system of claim 9, further comprising:
a) a player module, in communication with the calling module, and configured to play the single file.

11. The multimedia presentation system of claim 10, wherein the player module includes:
a) a first obstruction mode, configured to obstruct a portion of the functional browser content; and
b) a second access mode, configured to provide access to a portion of the functional browser content.

12. The multimedia presentation system of claim 11, further comprising:
a) a browser layer, in communication with the player module, wherein the single file is played in the browser layer.

13. The multimedia presentation system of claim 12, further comprising:
a) a chroma-key module, in communication with the data collection module, and configured to chroma-key the full motion video data.

14. The multimedia presentation system of claim 13, wherein the single file is a streaming video file that plays an alpha key.

15. The multimedia presentation system of claim 14, wherein the calling module includes:
a) a layer creation module, configured to create the browser layer;
b) a video player module, configured to direct playback of the single file; and
c) a transparency module, configured to cause the browser layer to be transparent.

16. A method of providing multimedia content, comprising:
a) capturing data;
b) capturing full motion video data;
c) collecting the audio data and the full motion video data together in a single file;
d) storing the single file in a data storage module in communication with a network;
e) providing a single file over the network when triggered by a triggering event; and
f) playing the single file by displaying the full motion video data over a functional webpage.

17. The method of claim 16, wherein the step of displaying the full motion video data comprises an instance of a first mode wherein a functional portion of a webpage is obscured and an instance of a second mode wherein the functional portion of the webpage is not obscured.

18. The method of claim 17, further comprising the step of providing a browser layer, wherein the step of playing the single file is performed in the browser layer.

19. The method of claim 18, wherein the triggering event comprises a browser executing a webpage program module.

20. The method of claim 19, wherein the triggering event further comprises a user action selected from the group consisting of: closing a browser window, moving an indicator over a display region, and actuating a display region.
